(19) United States
(12) Patent Application Publication
(10) Pub. No.: US 2006/0093232 A1
(43) Pub. Date: May 4, 2006

(54) Unified metric for digital video processing (umdvp)

(75) Inventors: Yibin Yang, Pine Brook, CA (US); Lilla Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: koninkjkle phillips electronics n.v

(21) Appl. No.: 10/538,208

(22) PCT Filed: Dec. 4, 2003
(86) PCT No.: PCT/IB03/05717

§ 371 Date: Jun. 9, 2005

(30) Foreign Application Priority Data
Dec. 10, 2002 (US) 60432307

(51) Int. Cl. G06K 9/40

(52) U.S. Cl. 382/254

(57) ABSTRACT

The present application develops a unified metric for digital video processing (UMDVP) to control video processing algorithms. The UMDVP metric is defined based on coding information of MPEG encoded video for each pixel in a frame. The definition of the UMDVP metric includes local spatial features. The UMDVP metric can be used to control enhancement algorithms to determine how much a pixel can be enhanced without boosting coding artifacts. It can also be used to instruct artifact reduction algorithms where and how much reduction operations are needed.

The system and method of the present invention is directed to a unified metric for controlling digital video post-processing where the metric reflects local picture quality of an MPEG encoded video. More particularly, the system and method of the invention provides a metric that can be used to direct a post-processing system in how much to enhance a pixel or how much to reduce the artifact, thereby achieving optimum quality of the final post-processed result.

Compressed digital video sources have come into modern households through digital terrestrial broadcast, digital cable/satellite, PVR (Personal Video Recorder), DVD, etc. The emerging digital video products are bringing revolutionary experiences to consumers. At the same time, they are also creating new challenges for video processing functions. For example, low bit rates are often chosen to achieve bandwidth efficiency. The lower the bit rates, the more objectionable become the impairments introduced by the compression encoding and decoding processing.

For digital terrestrial television broadcasting of standard-definition video, a bit rate of around 6 Mbit/s is considered a good compromise between picture quality and transmission bandwidth efficiency, see P. N. Tudor, “MPEG-2 Video Compressions,” IEEE Electronics & Communication Engineering Journal, December 1995, pp. 257-264. However, broadcasters sometimes choose bit rates far lower than 6 Mbit/s to have more programs per multiplex. Meanwhile, many processing functions fail to take the digital compression into account. As a result, they may perform sub-optimally on the compressed digital video.

MPEG-2 has been widely adopted as a digital video compression standard, and is the basis of new digital television services. Metrics for directing individual MPEG-2 post-processing techniques have been developed. For example, in Y. Yang and L. Boroczky, “A New Enhancement Method for Digital Video Applications”, IEEE Transactions on Consumer Electronics, Vol. 48, No. 3, August 2002, pp. 435-443, the entire contents of which are hereby incorporated by reference as if fully set forth herein, the inventors define a usefulness metric (UME: Usefulness Metric for Enhancement) for improving the performance of sharpness enhancement algorithms for post-processing of decoded compressed digital video. However, a complete digital video post-processing system must include not only sharpness enhancement but also resolution enhancement and artifact reduction. UME's and other metrics' focus on sharpness enhancement alone limits their usefulness.

Picture quality is one of the most important aspects for digital video products (e.g., DTV, DVD, DVD record, etc.). These products receive and/or store video resources in MPEG-2 format. The MPEG-2 compression standard employs a block-based DCT transform and is a lossy compression that can result in coding artifacts that reduce picture quality. The most common and visible of these coding artifacts are blockiness and ringing. Among the video post-processing functions performed in these products, sharpness enhancement and MPEG-2 artifact reduction are the two key functions for quality improvement. It is extremely important for these two functions not to cancel out each other's effects. For instance, MPEG-2 blocking artifact reduction tends to blur the picture while sharpness enhancement makes the picture sharper. If the interaction between these two functions is ignored, the end result may be to restore the blocking effect by the sharpness enhancement even though the early blocking artifact reduction operation reduced the block effect.

Blockiness manifests itself as visible discontinuities at block boundaries due to the independent coding of adjacent blocks. Ringing is most evident along high contrast edges in areas of generally smooth texture and appears as ripples extending outwards from the edge. Ringing is caused by abrupt truncation of high frequency DCT components, which play significant roles in the representation of an edge.

No current metric is designed to direct the joint application of enhancement and artifact reduction algorithms during post-processing.

Thus, there is a need for a metric which can be used to direct post-processing that effectively combines quality improvement functions so that total quality is increased and negative interactions are reduced. The system and method of the present invention provides a metric for directing the integration and optimization of a plurality of post-processing functions, such as, sharpness enhancement, resolution enhancement and artifact reduction. This metric is A Unified Metric for Digital Video Processing (UMDVP) that can be used to jointly control a plurality of post-processing techniques.

UMDVP is designed as a metric based on the MPEG-2 coding information.

UMDVP quantifies how much a pixel can be enhanced without boosting coding artifacts. In addition, UMDVP provides information about where artifact reduction functions should be carried out and how much reduction needs to be done. By way of example and not limitation, in a preferred embodiment, two coding parameters are used as a basis for UMDVP: the quantisation parameter (q_scale) and the number of bits spent to code a luminance block (num_bits). More specifically, num_bits is defined as the number of bits spent to code the AC coefficients of the DCT block. q_scale is the quantization for each 16×16 macroblock and can be easily extracted from every bitstream. Furthermore, while decoding a bitstream, num_bits can be calculated for each 8×8 block with little computational cost. Thus, the overall overhead cost of collecting the coding information is negligible.

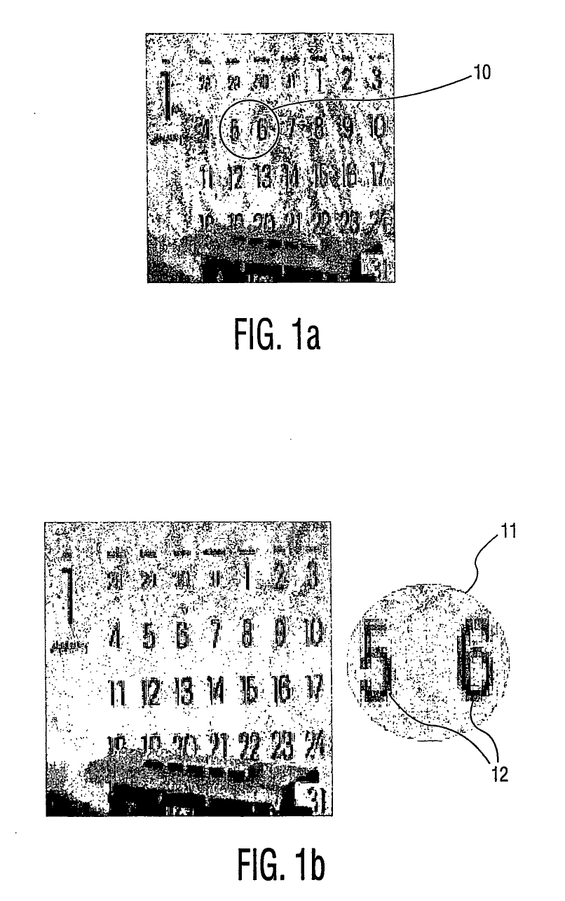

FIG. 1a illustrates a snapshot from a “Calendar” video sequence encoded at 4 Mbits/s.

FIG. 1b illustrates an enlargement of an area of FIG. 1a that exhibits ringing artifacts.

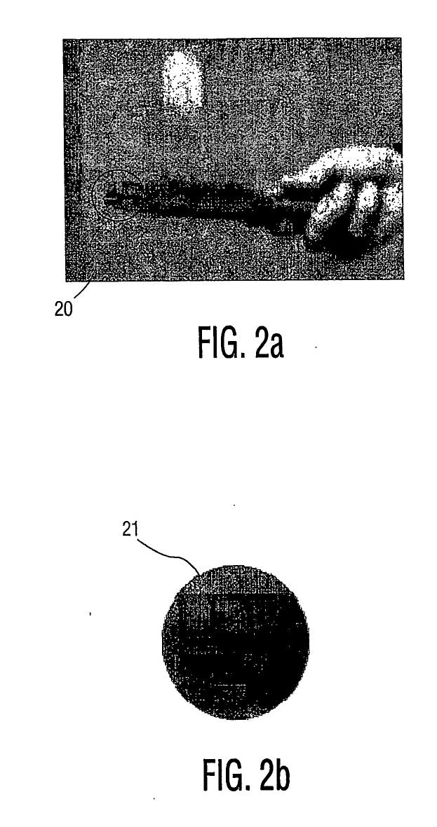

FIG. 2a illustrates a snapshot from a “Table-tennis” sequence encoded at 1.5 Mbits/s.

FIG. 2b illustrates an enlargement of an area of FIG. 2a that exhibits blocking artifacts.

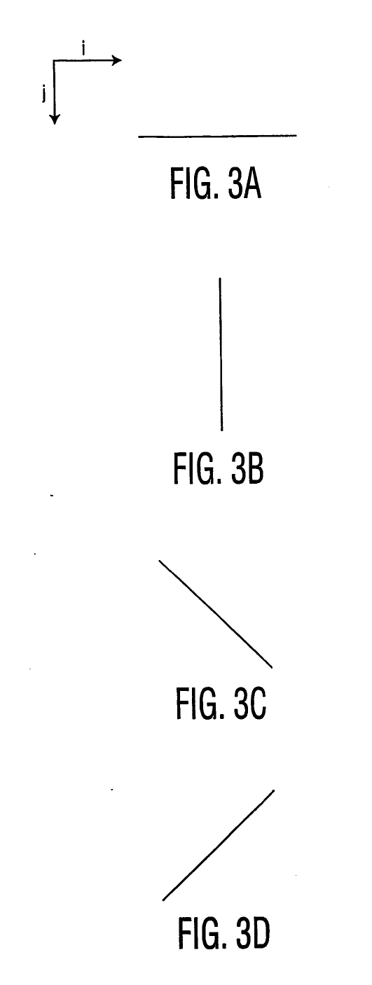

FIG. 3a illustrates a horizontal edge, according to an embodiment of the present invention.

FIG. 3b illustrates a vertical edge, according to an embodiment of the present invention.

FIGS. 3c and 3d illustrate diagonal edges for 45 and 135 degrees, according to an embodiment of the present invention.

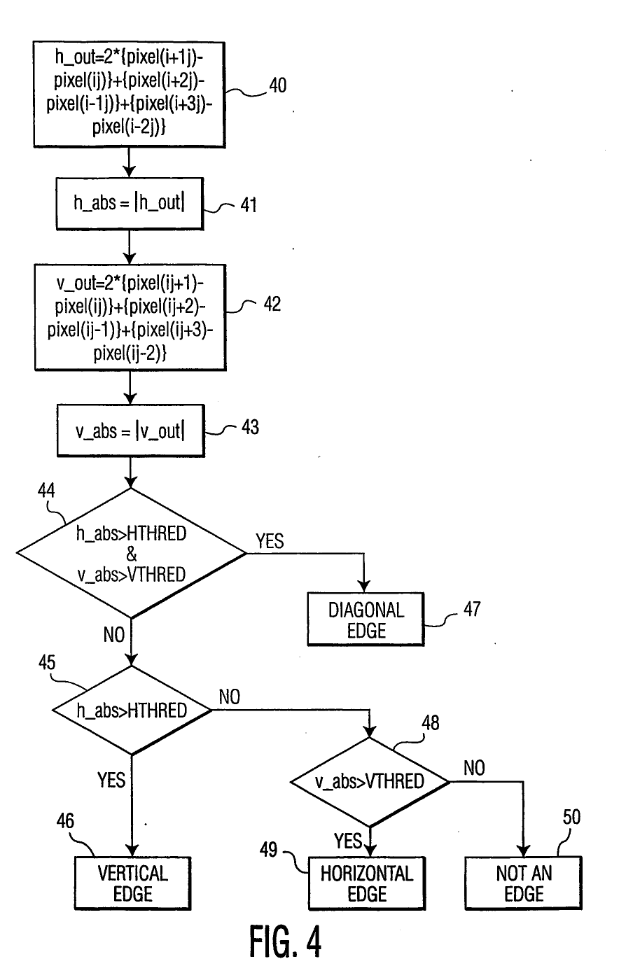

FIG. 4 illustrates a flow chart of an exemplary edge detection algorithm, according to an embodiment of the present invention.

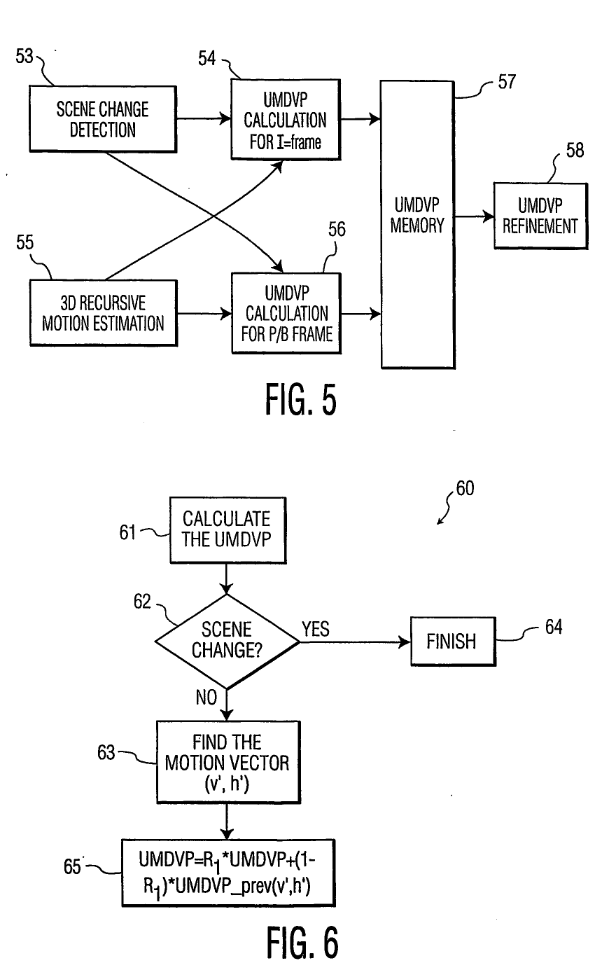

FIG. 5 is a system diagram of an exemplary apparatus for calculation of the UMDVP metric, according to an embodiment of the present invention.

FIG. 6 illustrates a flowchart of an exemplary calculation of the UMDVP metric for I-frames, according to an embodiment of the present invention.

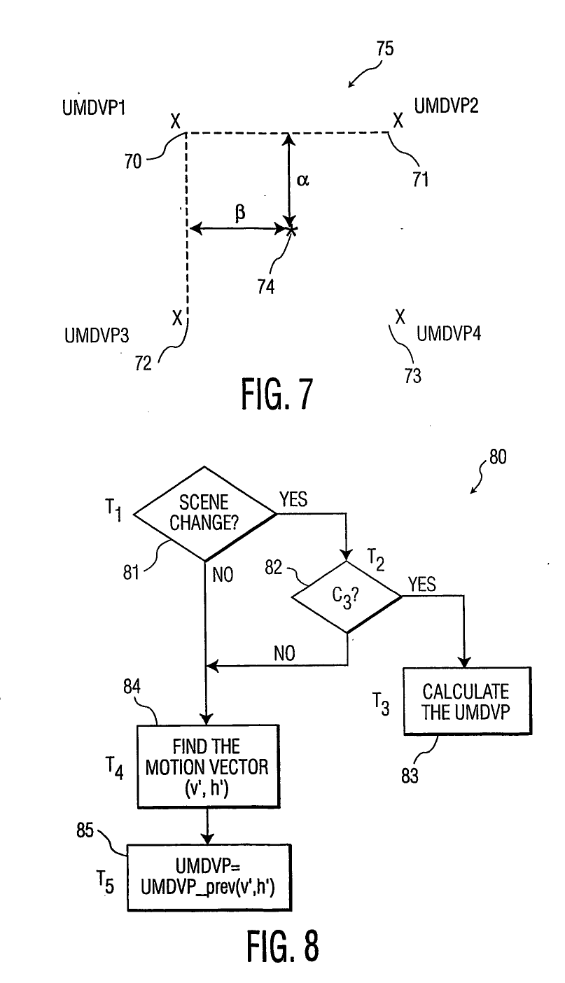

FIG. 7 illustrates an exemplary interpolation scheme for use in calculating the UMDVP metric, according to an embodiment of the present invention

FIG. 8 illustrates an exemplary flow chart of an algorithm for calculation of the UMDVP metric for P or B frames, according to an embodiment of the present invention.

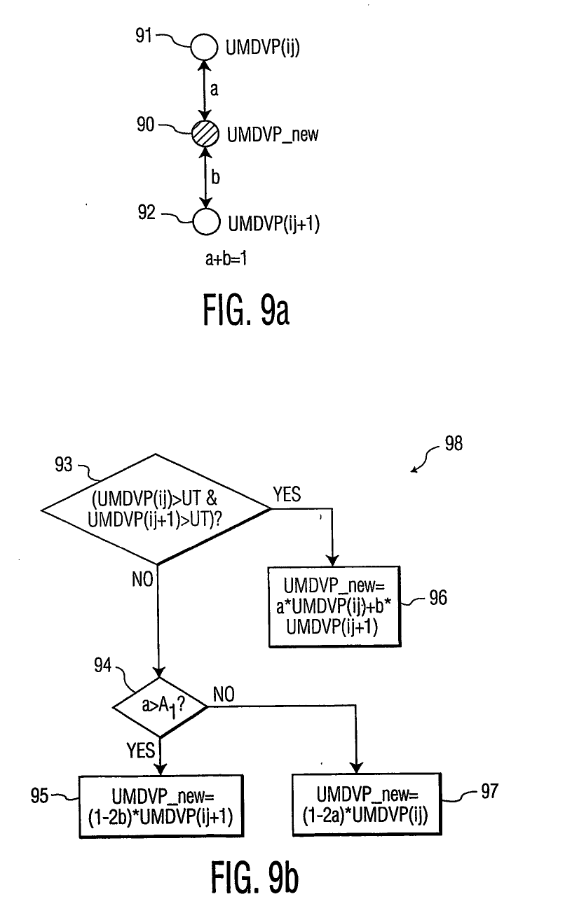

FIG. 9 illustrates a vertical interpolation scaling scheme of the present invention.

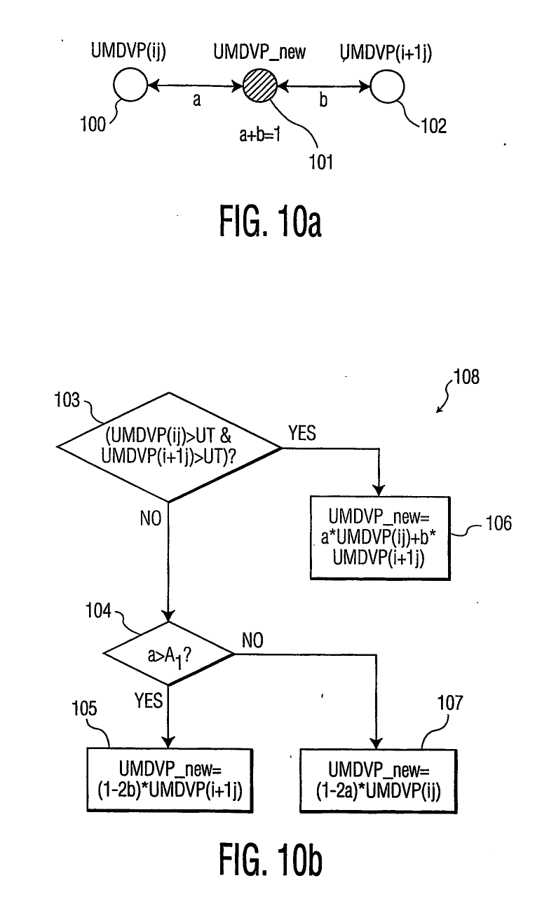

FIG. 10 illustrates a horizontal interpolation scaling schema of the present invention.

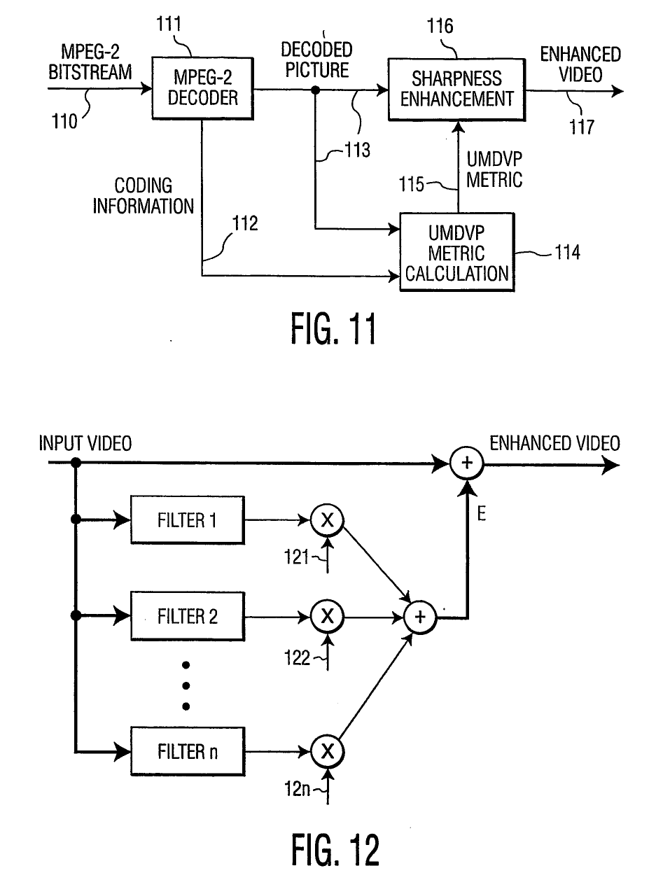

FIG. 11 illustrates a system diagram for an exemplary sharpness enhancement apparatus, according to an embodiment of the present invention.

FIG. 12 illustrates the fundamental structure of a convention peaking algorithm.

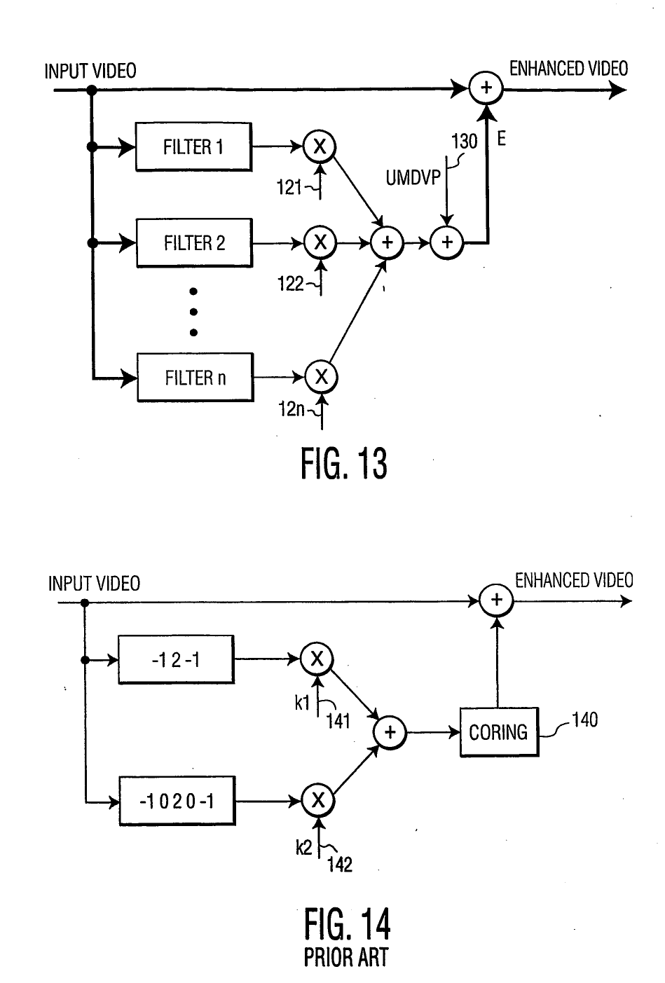

FIG. 13 illustrates applying the UMDVP metric to pealing algorithms to control how much enhancement is added to the original signal.

FIG. 14 illustrates a specific peaking algorithm.

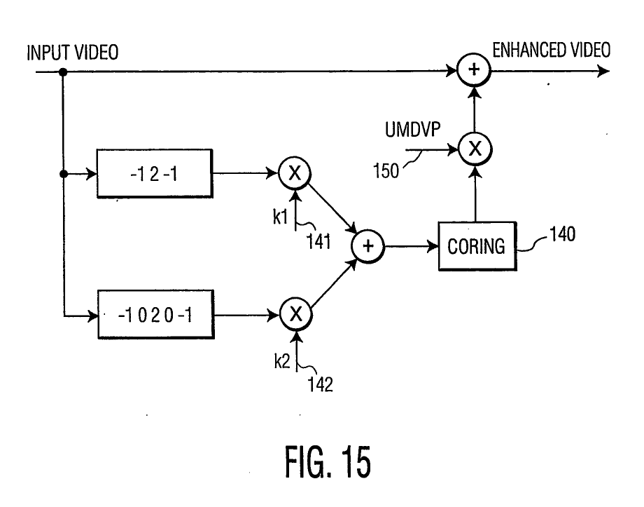

FIG. 15 illustrates using the UMDVP metric to prevent the enhancement of coding artifacts in the apparatus illustrated in FIG. 14.

The relationship between picture quality of compressed digital video sources and coding information is well known, i.e., picture quality of a compressed digital video is directly affected by how it has been encoded. The UMDVP metric of the present invention is based on the MPEG-2 coding information and quantifies how much a pixel can be enhanced without boosting coding artifacts. In addition, it can also point out where artifact reduction functions should be carried out and how much reduction needs to be done.

1. Unified Metric for Digital Video Processing (UMDVP)

UMDVP uses the coding information such as the quantisation parameter (q_scale) and the number of bits spent to code a luminance block (num_bits). q_scale is the quantisation scale for each 16×16 macroblock. Both are easily extracted from every bitstream.

1.1 Quantisation Scale (q_scale)

MPEG schemes (MPEG-1, MPEG-2 and MPEG-1) use quantisation of the DCT coefficients as one of the compression steps. But, quantisation inevitably introduces errors. The representation of every 8×8 block can be considered as a carefully balanced aggregate of each of the DCT basis images. Therefore a high quantisation error may result in errors in the contribution made by the high-frequency DCT basis images. Since the high-frequency basis images play a significant role in the representation of an edge, the reconstruction of the block will include high-frequency irregularities such as ringing artifacts. FIG. 1a illustrates a snapshot from a “Calendar” video sequence encoded at 4 Mbit/s. The circled part 10 of FIG. 1a is shown enlarged 11 in FIG. 1b, in which ringing artifacts 12 can be seen around the edges of the digits.

The larger the value of q_scale the higher is the quantisation error. Therefore, UMDVP is designed to increase as q_scale decreases.

1.2 The Number of Bits to Code a Block (num_bits)

MPEG-2 uses a block-based coding technique with a block-size of 8 by 8. Generally, the fewer bits used to encode a block the more information of the block that is lost and the lower the quality of the reconstructed block. However, this quantity is also highly dependent on scene content, bit rate, frame type (such as I, P and B frames), motion estimation, and motion compensation.

For a non-smooth area, if num_bits becomes 0 for an intra-block, it implies that only the DC coefficient remains while all AC coefficients are absent. After decoding, blocking effects may exist around this region. FIG. 2a is a snapshot from a “Table-tennis” sequence encoded at 1.5 Mbit/s. The blocking effect is very clear in the circled area 20 of FIG. 2a that is shown enlarged 21 in FIG. 2b.

The smaller num_bits, the more likely coding artifacts exist. As a result, the UMDVP value is designed to decrease as num_bits decreases.

1.3 Local Spatial Feature

Picture quality in an MPEG-based system is dependent on both the available bit rate and the content of the program being shown. The two coding parameters: q_scale and num_bits only reveal information about the bit rate. The present invention defines another quantity to reflect the picture content. In the present invention, a local spatial feature quantity is defined as an edge-dependent local variance used in the definition of UMDVP.

1.3.1 Edge Detection

Before calculating this local variance at pixel (i,j), it must be determined if the pixel(i,j) belongs to an edge. If it does, the edge direction is determined. The present invention only considers three kinds of edges, as shown in FIG. 3a for horizontal edges, FIG. 3b for vertical edges and FIGS. 3c and 3d for diagonal edges (45 or 135 degrees). FIG. 4 illustrates a flowchart of an exemplary edge detection algorithm. At step 41 and step 43, two variables (h_abs and v_abs) are calculated based on h_out and v_out, which are calculated in steps 40 and 42, respectively. Then these two variables are measured against the corresponding thresholds: HTHRED and VTHRED at step 44. If h_abs and v_abs are larger than HTHRED and VTHRED respectively, it is determined at step 47 that pixel (i,j) belongs to a diagonal edge. Otherwise if h_abs is larger than HTHRED but v_abs is smaller than or equal to VTHRED, it is determined at step 46 that pixel (i,j) belongs to a vertical edge. If v_abs is larger than VTHRED but h_abs is smaller than or equal to HTHRED, it is determined at step 49 that pixel (i,j) belongs to a horizontal edge. Finally if h_abs and v_abs are smaller than or equal to HTHRED and VTHRED respectively, it is determined at step 50 that pixel (i,j) does not belong to an edge. By way of example and not limitation, in a preferred embodiment, the two thresholds, V-THRED and H_THRED, are set to 10. Furthermore, to make the edge detection more robust an extra step is applied to eliminate the isolated edge points:
1. If pixel(i,j) is identified as a horizontal edge pixel and if neither pixel(i−1,j) nor pixel(i+1,j) belong to a horizontal edge then pixel(i,j) will be disqualified as an edge pixel;
2. If pixel(i,j) is identified as a vertical edge pixel and if neither pixel(i,j−1) nor pixel(i,j+1) belongs to a vertical edge then pixel(i,j) will be disqualified as an edge pixel; and
3. If pixel(i,j) is identified as a diagonal pixel and if none of pixel(i−1,j−1), pixel(i−1,j+1), pixel(i+1,j−1), and pixel(i+1,j+1) belong to a horizontal edge, pixel(i,j) will be disqualified as an edge pixel.
   1.3.2 Edge-Dependent Local Variance

When pixel (i,j) belongs to a horizontal edge, the edge-dependent local variance is defined as:

$$\begin{matrix}var ( i , j ) = \vert pixel ( i , j - 1 ) - mean \vert + \vert pixel ( i , j ) - mean \vert + \vert pixel ( i , j + 1 ) - mean \vert \\ where & ( 1 ) \\ mean = \frac{( {\sum }_{q = - 1}^{1} pixel ( i , j + q ) )}{3} & ( 2 )\end{matrix}$$

When pixel (i,j) belongs to a vertical edge, the edge-dependent local variance is defined as:

$$\begin{matrix}var ( i , j ) = \vert pixel ( i - 1 , j ) - mean \vert + \vert pixel ( i , j ) - mean \vert + \vert pixel ( i + 1 , j ) - mean \vert \\ where & ( 3 ) \\ mean = \frac{( {\sum }_{q = - 1}^{1} pixel ( i + q , j ) )}{3} & ( 4 )\end{matrix}$$

When pixel(i,j) belongs to a diagonal edge, the edge-dependent local variance is defined as:

$$\begin{matrix}var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert \\ where & ( 5 ) \\ mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5} & ( 6 )\end{matrix}$$

When pixel(i,j) does not belong to any of the aforementioned edges, the variance is defined as:

$$\begin{matrix}var ( i , j ) = {\sum }_{p = - 1}^{1} {\sum }_{q = - 1}^{1} \vert pixel ( i + p , j + q ) - mean \vert \\ where & ( 7 ) \\ mean = \frac{( {\sum }_{p = - 1}^{1} {\sum }_{q = - 1}^{1} pixel ( i + p , j + q ) )}{9} & ( 8 )\end{matrix}$$

The edge-dependent local variance reflects the local scene content of the picture. This spatial feature is used in the present invention to adjust and refine the UMDVP metric.
1.4 Definition of UMDVP

By way of example and not limitation, UMDVP can be defined based on observations of the two coding parameters (num_bits and q_scale), as the following function:

$$UMDVP = \frac{\frac{num\_bits}{q\_scale} - Q\_OFFSET}{Q\_OFFSET} \qquad ( 9 )$$

where Q_OFFSET is an experimentally determined value. By way of example and not limitation, Q_OFFSET can be determined by analyzing the bitstream while taking quality objectives into account. A value of 3 is used for Q_OFFSET in a preferred embodiment of the present invention. The UMDVP value is limited to the range of [−1,1]. If num_bits equals to 0, UMDVP is set to 0. Taking the local spatial feature into account, the UMDVP value is further adjusted as follows:
UMDVP=UMDVP+1 if ((UMDVP<0)&(var>VAR_THRED)) (10)
where VAR_THRED is a pre-determined threshold that is empirically determined. By way of example and not limitation, VAR_THRED can be determined by analyzing the bit stream while taking quality objectives into consideration.

The value of UMDVP is further refined by the edge-dependent local variance:

$$UMDVP ( i , j ) = UMDVP ( i , j ) * {( \frac{var ( i , j )}{VAR\_THRED} )}^{3} \qquad ( 11 )$$

Here again, the UMDVP value is limited to the range between −1 and 1, inclusive. A value of 1 for UMDVP means that sharpness enhancement is absolutely allowed for a particular pixel, while if the value is −1, the pixel can not be enhanced and artifact reduction operations are needed.
2. UMDVP Calculation For MPEG-2 Video

The UMDVP metric is calculated differently depending on whether the frame is an I-frame, P-frame or B-frame. Motion estimation is employed to ensure temporal consistency of the UMDVP, which is essential to achieve temporal consistency of enhancement and artifact reduction. Dramatic scene change detection is also employed to further improve the performance of the algorithm. The system diagram of the UMDVP calculation for MPEG-2 video is illustrated in FIG. 5.

2.1 Motion Estimation (55)

By way of example and not limitation, an embodiment of the present invention employs a 3D recursive motion estimation model described in Gerard de Haan et al, “True-Motion Estimation with 3-d Recursive Search Block Matching”, IEEE Transactions on Circuits and Systems for Video Technology, Vol. 3, No. 5, October 1993, pp 368-379, the entire contents of which are hereby incorporated by reference as if fully set forth herein. Compared with a block-based full-search technique, this 3D model dramatically reduces the computational complexity while improving the consistency of motion vectors.

2.2 Scene Change Detection (53)

Scene change detection is an important step in the calculation of the UMDVP metric, as a forced temporal consistency between different scenes can result in picture quality degradation, especially if dramatic scene change occurs.

The goal of scene change detection is to detect the content change of consecutive frames in a video sequence. Accurate scene change detection can improve the performance of video processing algorithms. For instance, it is used by video enhancement algorithms to adjust parameters for different scene content. Scene change detection is also useful in video compression algorithms.

Scene change detection may be incorporated as a further step in the UMDVP calculation, as a forced temporal consistency between different scenes can result in picture quality degradation, especially if a dramatic scene change occurs.

Any known scene change detection method can be used. By way of example and not limitation, in a preferred embodiment, a histogram of the differences between consecutive frames is examined to determine if a majority of the difference values exceed a predetermined value.

2.3 UMDVP Calculation for I, P and B Frames (54) & (56)

FIG. 6 illustrates a flowchart of a preferred embodiment of the calculation of the UMDVP metric for I-frames. At the first step 61, an initial UMDVP value is calculated by Eq. (9). Then dramatic scene change detection is applied at 62. If a scene change has occurred, the calculation ends at 64. Otherwise, motion estimation is used to find the motion vector (v′,h′) (63) for the current 8×8 block. In FIG. 6, UMDVP_prev(v′,h′) is the value of the UMDVP metric at the location pointed by (v′,h′) in the previous frame. If the position pointed at by (v′,h′) does not co-site with a pixel, an interpolation is needed to obtain the value of the UMDVP metric.

The interpolation scheme is illustrated in FIG. 7. Suppose it is necessary to interpolate the UMDVP value at the location indicated by “*” from the values of the UMDVP values at the locations indicated by ‘X’. Assuming the value of the UMDVP metric at the top-left corner is UMDVP1 70, the one at the top-right corner is UMDVP2 71, the one at the bottom-left corner is UMDVP3 72, and the one at the bottom-right corner is UMDVP4 73.
UMDVP=(1−β)×((1−α)×UMVP1+×αUMDVP3)+β×((1−α)×UMDVP2+α×UMDVP4) (12)
At step 65, the value of the UMDVP metric is adjusted based on the calculated value of the UMDVP metric at step 61 or the interpolated value of the UMDVP metric and the value of the UMDVP metric at the location pointed at by (v′,h′) in the previous frame and, in a preferred embodiment, R₁ is set to 0.7 to put more weight on the calculated value of the UMDVP metric
UMDVP=R₁×UMDVP+(1−R₁)×UMDVP_{—}prev(v′,h′) (13)

FIG. 8 illustrates a flow chart for a calculation of the value of the UMDVP metric for P or B frames. First, it is determined at step 81 whether there is a scene change. If so, the condition C₃, ((Intra-block) and (num_bits≠0)) is tested at step 82. If the condition is satisfied, the value of the UMDVP metric is calculated at step 83 by Eq. (9). If the condition is not satisfied, or no scene change is detected at step 81, motion estimation is applied to find the motion vector (v′,h′) for the current block at step 84. The value of the UMDVP metric is set to be the one pointed at by (v′,h′) in the previous frame at step 85. Again, the interpolation scheme of Eq. (12) is needed if the position pointed at by (v′,h′) is not exactly at a pixel location.

The final block “UMDVP refinement” 58 in FIG. 5 uses Eq. (10) and Eq. (11) to adjust and refine the UMDVP value by the edge-dependent local variance.

The UMDVP memory 57 is used to store intermediate results.

2.4 UMDVP Scaling

If the video processing algorithm runs not on the original resolution but on some higher resolution, scaling functions are needed for the UMDVP map to align with the new resolution. Vertical and horizontal scaling functions may be required for UMDVP alignment

2.4.1 Vertical Scaling

In FIG. 9a, the solid black circle 90 represents the location of the UMDVP value to be interpolated. If, at step 94 a>A₁ (A₁ is set to 0.5 in a preferred embodiment), which means the interpolated location is closer to (i,j+1) than to (i,j), then UMDVP_new 90 is more related to UMDVP(i,j+1) 92 than to UMDVP(i,j) 91. Therefore, at step 95 UMDVP_new is set to (1−2b)*UMDVP(i,j+1). The smaller the value of b, the closer the new interpolated UMDVP_new 90 is to UMDVP(i,j+1) 92. Otherwise, if at step 94 a≦A₁, which means the interpolated location is closer to (i,j), then UMDVP-new 90 is more related to UMDVP(i,j) than to UMDVP(i,j+1). Therefore, at step 97 UMDVP_new is set to (1−2a)*UMDVP(i,j). However, if it is determined at step 93 that both UMDVP(i,j) 91 and UMDVP(i,j+1) 92 are larger than UT (in a preferred embodiment UT is set to 0.3), which means the neighborhood is a homogeneous area with large UMDVP values, a bilinear interpolation is used at step 96 to generate UMDVP_new 90 as UMDVP_new=a*UMDVP(i,j)+b*UMDVP(i,j+1).

2.4.2 Horizontal Scaling

In FIG. 10a, the solid black circle 101 represents the location of the UMDVP value to be interpolated. If, at step 104 a>A₁ (A₁ is set to 0.5 in a preferred embodiment), which means the interpolated location is closer to (i+1,j) than to (i,j), UMDVP_new 101 is more related to UMDVP(i+1,j) 102 than to UMDVP(i,j) 100. Therefore, at step 105 UMDVP_new 101 is set to (1−2b)*UMDVP(i+1,j). The smaller the value of b, the closer the new interpolated UMDVP_new 101 is to UMDVP(i+1,j) 102. Otherwise, if, at step 104 a≦A₁, which means the location is closer to (i,j), UMDVP_new 101 is more related to UMDVP(i,j) 100 than to UMDVP(i+1,j) 102. Therefore, at step 107, UMDVP_new 101 is set to (1−2a)*UMDVP(i,j). However, if both UMDVP(i,j) 100 and UMDVP(i+1j) 102 are larger than UT (in a preferred embodiment UT is set to 0.3), which means the neighborhood is a homogeneous area with large UMDVP values, at step 106 a bilinear interpolation is used to generate UMDVP_new=a*UMDVP(i,j)+b*UMDVP(i,j+1).

3. Sharpness Enhancement Using UMDVP for MPEG-2 Encoded Video

By way of example and not limitation, sharpness enhancement algorithms attempt to increase the subjective perception of sharpness for a picture. However, the MPEG-2 encoding process may introduce coding artifacts. If an algorithm does not take the coding information into account, it may boost the coding artifacts.

By contrast, by using the UMDVP metric it is possible to instruct an enhancement algorithm as to how much to enhance the picture without boosting artifacts.

3.1 System Diagram

FIG. 11 illustrates a system diagram of a sharpness enhancement apparatus for MPEG-2 video using the UMDVP metric. The MPEG-2 decoder 111 sends out the coding information 112, such as q_scale and num_bits, to the UMDVP calculation module 114 while decoding the video bitstream. The details of the UMDVP calculation module 114 are illustrated in FIG. 5. The values of the UMDVP metric are used to instruct the sharpness enhancement module 116 on how much to enhance the picture.

3.2 Sharpness Enhancement

Sharpness enhancement techniques include peaking and transient improvement Peaking is a linear operation that uses, for example, in a preferred embodiment, the well-known “Mach Band” effect to improve the sharpness impression. Transient improvement, e.g. luminance transient improvement (LTI) is a well-known non-linear approach that modifies the gradient of the edges to enhance the sharpness.

3.2.1 Integration of the UMDVP Metric and Peaking Algorithms

Peaking increases the amplitude of the high-band, and/or middle-band frequency using linear filtering methods, usually one or several FIR-filters. FIG. 12 illustrates the fundamental structure of a peaking algorithm. The control parameters 121 to 12n may be generated by some control functions, which are not shown. They control the amount of peaking at each frequency band.

A straightforward method of applying the UMDVP metric 130 to peaking algorithms is to use the UMDVP metric to control how much enhancement is added to the original signal. FIG. 13 shows the structure. In a preferred embodiment, Eq. (14) is employed to adjust the value of the UMDVP metric before applying it to an enhancement algorithm.

$$UMDVP = \{ \begin{matrix}UMDVP & UMDVP \leq 0.3 \\ UMDVP + 0.5 & 0.3 < UMDVP < 0.5 \\ 1.0 & UMDVP \geq 0.5\end{matrix} \qquad ( 14 )$$

When the value of the UMDVP metric is larger than 0.3, it is increased by 0.5. The assumption here is that if the value UMDVP metric is above some threshold (0.3 in this case), the picture quality is good enough so that sharpness enhancement should not be oversuppressed.

A specific example of sharpness enhancement using the UMDVP metric

By way of example and not limitation, the approach described in G. de Haan, Video Processing for Multimedia Systems, University Press, Eindhoven, The Netherlands, 2000, allows peaking at two parts of the signal spectrum, typically taken at a half and at a quarter of the sampling frequency. FIG. 14 illustrates this method which is described below.

Let f(\vec{x}, n) be the luminance signal at pixel position \vec{x}=(x,y) in picture n. Using the z-transform, we can describe the peaked luminance signal fₚ(\vec{x}, n), as:

$${F}_{p} ( Z ) = F ( Z ) + {k}_{1} ( - 1 {z}^{- 1} + 2 {z}^{0} - 1 {z}^{1} ) F ( Z ) + {k}_{2} ( - 1 {z}^{- 2} + 2 {z}^{0} - 1 {z}^{2} ) F ( Z ) \qquad ( 15 )$$

where k₁ 141 and k₂ 142 are control parameters determining the amount of peaking at the middle and the highest possible frequencies, respectively.

To prevent noise degradation, a common remedy is to only boost the signal components if they exceed a pre-determined amplitude threshold. This technique is known as ‘coring’ 140 and can be seen as a modification of k₁ and k₂ in Eq.(15).

The peaking algorithm described above enhances the subjective perception of sharpness, but at the same time it can also enhance the coding artifacts. To prevent this problem, the UMDVP metric 150 can be used to control the peaking algorithm as shown in FIG. 15.

Both enhancement and artifact reduction functions are required to achieve an overall optimum result for compressed digital video. The balance between enhancement and artifact reduction for digital video is analogous to the balance between enhancement and noise reduction for analog video. The optimization of the overall system is not trivial. However, UMDVP can be used both for enhancement algorithms and artifact reduction functions.

The methods and systems of the present invention, as described above and shown in the drawings, provide for a UMDVP metric to jointly control enhancement and artifact reduction of a digital coded video signal. It will be apparent to those skilled in the art that various modifications and variations can be made in the method and system of the present invention without departing from the spirit or scope of the invention. Thus, it is intended that the present invention includes modifications and variations that are within the scope of the appended claims and their equivalents.

1. A system and method for directing post-processing to improve picture quality of a decoded digital video signal encoded as a sequence of at least one frame of block-based data, said system comprising:
a metric calculation unit for calculating a unified metric for digital video processing (UMDVP) for each pixel in the frame in accordance with a frame type to produce a UMDVP metric map, wherein the calculation unit comprises:
a module that defines local spatial features in the frame,
means for estimating block-based motion as one of a motion vector for the block of pixels and as at least one motion vector for the frame,
a module that detects a scene change in the frame,
means for scaling for the UMDVP metric map to align with the resolution of the decoded video when the UMDVP metric map does not align with the resolution of the decoded video, and
means for interpolating the value of UMDVP when the position pointed at by the motion vector does not co-site with a pixel; and
a post-processing unit having at least one quality improvement algorithm, wherein, said calculation unit produces a scaled and interpolated UMDVP metric map for the frame, said post-processing unit directs said at least one quality improvement algorithm to improve quality of a decoded version of the digital video signal based on the UMDVP metric map, said at least one quality improvement algorithm improves the quality of the decoded version of the digital video based on the UMDVP metric map, and said at least one quality improvement algorithm is selected from the group consisting of enhancement algorithms and artifact reduction algorithms.

2. The system of claim 1, wherein the calculation unit further comprises a module that analyzes macroblock and block-based coding information according to the formula:
$$UMDVP ( i , j ) = \frac{\frac{num\_bits}{q\_scale} - Q\_OFFSET}{Q\_OFFSET} for num\_bits \neq 0$$
$$UMDVP ( i , j ) = 0 for num\_bits = 0$$
wherein, UMDVP(i,j)∈[i,−1] is a metric for a pixel(i,j) of a block of pixel data, q_scale is a quantization scale for the macroblock, num_bits is a number of bits to encode a luminance block, and Q_OFFSET is an experimentally pre-determined value.

3. The system of claim 2, wherein:
if the calculation unit determines that the frame is an I frame type and the module that detects a scene change determines that a scene change has not occurred then refinements are to the calculated value of UMDVP as follows:
the calculation unit employs the means for estimating block-based motion to obtain a motion vector (v′,h′) for the current block,
if the position pointed at by the motion vector (v′,h′) does not co-site with a pixel, the calculation unit employs the means for interpolation to perform an interpolation to obtain the value of the UMDVP metric at the position pointed at by the motion vector, and the value of the UMDVP metric is adjusted using the equation
UMDVP=R₁×UMDVP+(1−R₁)×UMDVP_{—}prev(v′,h′)
wherein, UMDVP_prev(v′,h′) is the value of the UMDVP metric at the location pointed at by (v′,h′) in the previous frame and R₁ is a pre-determined weighting factor.

4. The system of claim 3, wherein the value of UMDVP is further adjusted and refined for a local spatial feature as follows:
$$UMDVP ( i , j ) = UMDVP ( i , j ) + 1$$
$$for$$
$$UMDVP ( i , j ) < 0 , ( var ( i , j ) > VAR\_THRED )$$
$$and$$
$$UMDVP ( i , j ) = UMDVP ( i , j ) * {( \frac{var ( i , j )}{VAR\_THRED} )}^{3}$$
wherein, var(i,j) is a variance defined for the local spatial feature and VAR_THRED is a pre-determined threshold that is empirically determined.

5. The system of claim 4, wherein the local spatial feature is an edge and the edge-dependent local variance is defined as:
when pixel (i,j) belongs to a horizontal edge, the edge-dependent local variance is defined as:
$$var ( i , j ) = \vert pixel ( i , j - 1 ) - mean \vert + \vert pixel ( i , j ) - mean \vert + \vert pixel ( i , j + 1 ) - mean \vert where mean = \frac{( {\sum }_{q = - 1}^{1} pixel ( i , j + q ) )}{3}$$
when pixel (i,j) belongs to a vertical edge, the edge-dependent local variance is defined as:
$$var ( i , j ) = \vert pixel ( i - 1. j ) - mean \vert + \vert pixel ( i , j ) - mean \vert + \vert pixel ( i + 1 , j ) - mean \vert where mean = \frac{( {\sum }_{q = - 1}^{1} pixel ( i + q , j ) )}{3}$$
when pixel(i,j) belongs to a diagonal edge, the edge-dependent local variance is defined as:
$$var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert where mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5}$$
when pixel(i,j) does not belong to any of the aforementioned edges, the variance is defined as:
$$var ( i , j ) = {\sum }_{p = - 1}^{1} {\sum }_{q = - 1}^{1} \vert pixel ( i + p , j + q ) - mean \vert where mean = \frac{( {\sum }_{p = - 1}^{1} {\sum }_{q = - 1}^{1} pixel ( i + p , j + q ) )}{9}$$

6. The system of claim 3, wherein the value of UMDVP is further adjusted and refined (58) for a local spatial feature as follows:
$$UMDVP ( i , j ) = UMDVP ( i , j ) + 1 for UMDVP ( i , j ) < 0 , ( var ( i , j ) > VAR\_THRED ) and UMDVP ( i , j ) = UMDVP ( i , j ) * {( \frac{var ( i , j )}{VAR\_THRED} )}^{3}$$
wherein, var(i,j) is a variance defined for the local spatial feature and VAR_THRED is a pre-determined threshold that is empirically determined.

7. The system of claim 6, wherein the local spatial feature is and edge and the edge-dependent local variance is defined as:
when pixel (i,j) belongs to a horizontal edge, the edge-dependent local variance is defined as:
$$var ( i , j ) = \vert pixel ( i , j - 1 ) - mean \vert + \vert pixel ( i , j ) - mean \vert + \vert pixel ( i , j + 1 ) - mean \vert where mean = \frac{( {\sum }_{q = - 1}^{1} pixel ( i , j + q ) )}{3}$$
when pixel (i,j) belongs to a vertical edge, the edge-dependent local variance is defined as:
$$var ( i , j ) = \vert pixel ( i - 1. j ) - mean \vert + \vert pixel ( i , j ) - mean \vert + \vert pixel ( i + 1 , j ) - mean \vert where mean = \frac{( {\sum }_{q = - 1}^{1} pixel ( i + q , j ) )}{3}$$
when pixel(i,j) belongs to a diagonal edge, the edge-dependent local variance is defined as:
$$var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert where mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5}$$
when pixel(i,j) does not belong to any of the aforementioned edges, the variance is defined as:
$$var ( i , j ) = {\sum }_{p = - 1}^{1} {\sum }_{q = - 1}^{1} \vert pixel ( i + p , j + q ) - mean \vert where mean = \frac{( {\sum }_{p = - 1}^{1} {\sum }_{q = - 1}^{1} pixel ( i + p , j + q ) )}{9}$$

8. The system of claim 2, wherein:
if the calculation unit determines that the frame is one of a P or B frame type then:
if the module that detects a scene change determines that a scene change has not occurred or the condition ((Intra-block) and (num_bits≠0)) is not satisfied then refinements are made to the calculated value of UMDVP as follows—
a. the calculation module employs the means for motion estimation to calculate a motion vector (v′,h′) for the current block,
b. if the position pointed at by (v′,h′) does not co-site with a pixel, the calculation unit employs the means for interpolation to perform an interpolation to obtain the value of the UMDVP metric at the position point at by the motion vector, and
c. the value of the UMDVP metric is set as follows
UMDVP=UMDVP_{—}prev(v′h′)
wherein UMDVP_prev(v′,h′) is the value of the UMDVP metric at the location pointed at by (v′,h′) in the previous frame.

9. The system of claim 8, wherein the value of UMDVP is further adjusted and refined for a local spatial feature as follows:
$$UMDVP ( i , j ) = UMDVP ( i , j ) + 1 for UMDVP ( i , j ) < 0 , ( var ( i , j ) > VAR\_THRED ) and UMDVP ( i , j ) = UMDVP ( i , j ) * {( \frac{var ( i , j )}{VAR\_THRED} )}^{3}$$
wherein, var(i,j) is a variance defined for the local spatial feature and VAR_THRED is a pre-determined threshold that is empirically determined.

10. The system of claim 9, wherein the local spatial feature is an edge and the edge-dependent local variance is defined as:
when pixel (i,j) belongs to a horizontal edge, the edge-dependent local variance is defined as:
$$var ( i , j ) = \vert pixel ( i , j - 1 ) - mean \vert + \vert pixel ( i , j ) - mean \vert + \vert pixel ( i , j + 1 ) - mean \vert where mean = \frac{( {\sum }_{q = - 1}^{1} pixel ( i , j + q ) )}{3}$$
when pixel (i,j) belongs to a vertical edge, the edge-dependent local variance is defined as:
$$var ( i , j ) = \vert pixel ( i - 1 , j ) - mean \vert + \vert pixel ( i , j ) - mean \vert + \vert pixel ( i + 1 , j ) - mean \vert where mean = \frac{( {\sum }_{q = - 1}^{1} pixel ( i + q , j ) )}{3}$$
when pixel(i,j) belongs to a diagonal edge, the edge-dependent local variance is defined as:
$$var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert$$
$$where$$
$$mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5}$$
when pixel(i,j) does not belong to any of the aforementioned edges, the variance is defined as:
$$var ( i , j ) = {\sum }_{p = - 1}^{1} {\sum }_{q = - 1}^{1} \vert pixel ( i + p , j + q ) - mean \vert where mean = \frac{( {\sum }_{p = - 1}^{1} {\sum }_{q = - 1}^{1} pixel ( i + p , j + q ) )}{9}$$

11. The system of claim 1, wherein the enhancement algorithm is a sharpness enhancement algorithm comprising one of peaking and transient improvement.

12. The system of claim 11, wherein:
the sharpness enhancement algorithm is a peaking algorithm; and
the UMDVP metric is adjusted as follows before applying it to the output of the peaking algorithm
$$UMDVP = \{ \begin{matrix}UMDVP & & UMDVP \leq 0.3 \\ UMDVP + 0.5 & when & 0.3 < UMDVP < 0.5 \\ 1.0 & & UMDVP \geq 0.5\end{matrix}$$

13. The system of claim 12, wherein the output of the peaking algorithm is controlled by the technique of coring and the UMDVP metric is applied to the output of the coring technique.

14. A method for directing post-processing to improve picture quality of a decoded digital video signal, said system comprising:
providing a module that defines local spatial features in the frame;
providing means for estimating block-based motion vectors for the frame;
providing a module that detects a scene change in the frame;
providing means for interpolating the UMDVP metric if the location pointed at by the motion vector does not co-site with a pixel;
calculating a unified metric UMDVP for digital video processing (UMDVP) for each pixel in the frame based on frame type, local spatial feature, block-based motion estimation, and detected scene changes;
producing a UMDVP metric map of the calculated UMDVP metric for each pixel;
if the UMDVP metric map does not align with the resolution of the decoded signal, scaling the metric map to align the UMDVP metric map with the resolution of the decoded signal; and
post-processing the frame by applying the UMDVP metric map to direct the selection and aggressiveness of at least one quality improvement algorithm selected from the group consisting of enhancement algorithms and artifact reduction algorithms.

15. The method of claim 14, wherein the calculating step further comprises the step of analyzing macroblock and block-based coding information and calculating the UMDVP metric according to the formula:
$$\begin{matrix}UMDVP ( i , j ) = \frac{\frac{num\_bits}{q\_scale} - Q\_OFFSET}{Q\_OFFSET} & for num\_bits \neq 0 \\ UMDVP ( i , j ) = 0 & for num\_bits = 0\end{matrix}$$
wherein, UMDVP(i,j)∈[1,−1] is a metric for a pixel(i,j) of a block of pixel data, q_scale is a quantization scale for the macroblock, num_bits is a number of bits to encode a luminance block, and Q_OFFSET is an experimentally predetermined value.

16. The method of claim 15, further comprising the steps of:
determining that the frame is an I frame type;
if a scene change has not been detected and the frame has been determined to be an I frame type, estimating a motion vector (v′,h′) for the current block by the means for estimating;
if the position pointed at by the motion vector (v′,h′) does not co-site with a pixel, performing an interpolation to obtain the value of the UMDVP metric at the position pointed at by the motion vector (v′,h′) by the means for interpolating; and
adjusting the value of the UMDVP metric using the equation
UMDVP=R₁×UMDVP+(1−R₁)×UMDVP_{—}prev(v′,h′)
wherein, UMDVP_prev(v′,h′) is the value of the UMDVP metric at the location pointed at by (v′,h′) in the previous frame and R₁ is a predetermined weighting factor.

17. The method of claim 16, further comprising the steps of:
adjusting the value of UMDVP for a local spatial feature as follows:
$$UMDVP ( i , j ) = UMDVP ( i , j ) + 1 for UMDVP ( i , j ) < 0 , ( var ( i , j ) > VAR\_THRED ) and UMDVP ( i , j ) = UMDVP ( i , j ) * {( \frac{var ( i , j )}{VAR\_THRED} )}^{3}$$
wherein, var(i,j) is a variance defined for the local spatial feature and VAR_THRED is a pre-determined threshold that is empirically determined.

18. The method of claim 17, further comprising the steps of:
if the local spatial feature is an edge, calculating the edge-dependent local variance is defined as:
when pixel (i,j) belongs to a horizontal edge, the edge-dependent local variance is defined as:
$$var ( i , j ) = \vert pixel ( i , j - 1 ) - mean \vert + \vert pixel ( i , j ) - mean \vert + \vert pixel ( i , j + 1 ) - mean \vert where mean = \frac{( {\sum }_{q = - 1}^{1} pixel ( i + j , q ) )}{3}$$
when pixel (i,j) belongs to a vertical edge, the edge-dependent local variance is defined as:
$$var ( i , j ) = \vert pixel ( i - 1 , j ) - mean \vert + \vert pixel ( i , j ) - mean \vert + \vert pixel ( i + 1 , j ) - mean \vert where mean = \frac{( {\sum }_{q = - 1}^{1} pixel ( i + q , j ) )}{3}$$
when pixel(i,j) belongs to a diagonal edge, the edge-dependent local variance is defined as:
$$var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert$$
$$where$$
$$mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5}$$
when pixel(i,j) does not belong to any of the aforementioned edges, the variance is defined as:
$$var ( i , j ) = {\sum }_{p = - 1}^{1} {\sum }_{q = - 1}^{1} \vert pixel ( i + p , j + q ) - mean \vert where mean = \frac{( {\sum }_{p = - 1}^{1} {\sum }_{q = - 1}^{1} pixel ( i + p , j + q ) )}{9} .$$

19. The method of claim 15, further comprising the steps of:
determining that the frame is one of a P or B frame type;
if a scene change has not been detected or the condition
((Intra-block) and (num_bits≠0))
is not satisfied, estimating a motion vector (v′,h′) for the current block by the means for estimating;
if the position pointed at by the motion vector (v′,h′) does not co-site with a pixel, obtaining the value of the UMDVP metric at the position pointed by the motion vector (v′,h′) by the means for interpolating; and
adjusting the value of the UMDVP metric using the equation
UMDVP=UMDVP_{—}prev(v′h′),
wherein, UMDVP_prev(v′,h′) is the value of the UMDVP metric at the location pointed at by (v′,h′) in the previous frame.

20. The method of claim 19, further comprising the steps of:
adjusting the value of UMDVP for a local spatial feature as follows:
$$UMDVP ( i , j ) = UMDVP ( i , j ) + 1$$
$$for$$
$$UMDVP ( i , j ) < 0 , ( var ( i , j ) > VAR\_THRED )$$
$$and$$
$$UMDVP ( i , j ) = UMDVP ( i , j ) * {( \frac{var ( i , j )}{VAR\_THRED} )}^{3}$$
wherein, vat(i,j) is a variance defined for the local spatial feature and VAR_THRED is a predetermined threshold that is empirically determined.

21. The method of claim 20, further comprising the steps of:
if the local spatial feature is an edge, calculating the edge-dependent local variance as:
when pixel (i,j) belongs to a horizontal edge, the edge-dependent local variance is defined as:
$$var ( i , j ) = \vert pixel ( i , j - 1 ) - mean \vert + \vert pixel ( i , j ) - mean \vert + \vert pixel ( i , j + 1 ) - mean \vert where mean = \frac{( {\sum }_{q = - 1}^{1} pixel ( i , j + q ) )}{3}$$
when pixel (i,j) belongs to a vertical edge, the edge-dependent local variance is defined as:
$$var ( i , j ) = \vert pixel ( i - 1 , j ) - mean \vert + \vert pixel ( i , j ) - mean \vert + \vert pixel ( i + 1 , j ) - mean \vert where mean = \frac{( {\sum }_{q = - 1}^{1} pixel ( i + q , j ) )}{3}$$
when pixel(i,j) belongs to a diagonal edge, the edge-dependent local variance is defined as:
$$var ( i , j ) = \vert pixel ( i - 1 , j - 1 ) - mean \vert + \vert pixel ( i , j ) - mean \vert + \vert pixel ( i - 1 , j + 1 ) - mean \vert + \vert pixel ( i + 1 , j - 1 ) - mean \vert + \vert pixel ( i + 1 , j + 1 ) - mean \vert where mean = \frac{\begin{matrix}( pixel ( i - 1 , j - 1 ) + pixel ( i - 1 , j + 1 ) + \\ pixel ( i , j ) + pixel ( i + 1 , j - 1 ) + pixel ( i + 1 , j + 1 ) )\end{matrix}}{5}$$
when pixel(i,j) does not belong to any of the aforementioned edges, the variance is defined as:
$$var ( i , j ) = {\sum }_{p = - 1}^{1} {\sum }_{q = - 1}^{1} \vert pixel ( i + p , j + q ) - mean \vert where mean = \frac{( {\sum }_{p = - 1}^{1} {\sum }_{q = - 1}^{1} pixel ( i + p , j + q ) )}{9} .$$

22. The method of claim 14, wherein the enhancement algorithm is a sharpness enhancement algorithm comprising one of peaking and transient improvement.

23. The method of claim 22, wherein:
the sharpness enhancement algorithm is a peaking algorithm; and
further comprising the step of adjusting the UMDVP metric as follows before applying it to the output of the peaking algorithm
$$UMDVP = \{ \begin{matrix}UMDVP & UMDVP \leq 0.3 \\ UMDVP + 0.5 when & 0.3 < UMDVP < 0.5 \\ 1.0 & UMDVP \geq 0.5\end{matrix} .$$

24. The method of claim 23, further comprising the steps of:
controlling the output of the peaking algorithm by the technique of coring; and
applying the UMDVP metric the output of the coring technique.
